(19) United States
(12) Patent Application Publication
(10) Pub. No.: US 2019/0051879 A1
(43) Pub. Date: Feb. 14, 2019

(54) SEPARATOR FOR RECHARGEABLE BATTERY AND RECHARGEABLE LITHIUM BATTERY INCLUDING THE SAME

(71) Applicants: SAMSUNG SDI CO., LTD., Yongin-si (KR); SAMSUNG ELECTRONICS CO., LTD., Suwon-si (KR)

(72) Inventors: Byungmin LEE, Suwon-si (KR); Hana KIM, Suwon-si (KR); Jungsue JANG, Suwon-si (KR); Myungkook PARK, Suwon-si (KR); Seung Rim YANG, Seongnam-si (KR); Bokyung JUNG, Suwon-si (KR); Minho CHO, Suwon-si (KR); Rae Sung KIM, Hwaseong-si (KR); Namhee LEE, Hwaseong-si (KR)

(21) Appl. No.: 16/100,099

(22) Filed: Aug. 9, 2018

(30) Foreign Application Priority Data
Aug. 10, 2017 (KR) 10-2017-0101746

(51) Int. Cl. H01M 2/16; H01M 10/0525

(52) U.S. Cl. CPC H01M 2/1613; H01M 10/0525; H01M 2/162; H01M 2/1673

(57) ABSTRACT

A separator for a rechargeable battery, and a rechargeable lithium battery including the same are provided. The separator includes a porous substrate, and a heat resistance layer on at least one surface of the porous substrate. The heat resistance layer may include an acryl-based copolymer, a polyvinyl alcohol-based polymer, and a sheet-shaped inorganic particle, where the sheet-shaped inorganic particle is selected from mica, clay, magnesium hydroxide (Mg(OH)₂), aluminum hydroxide (Al(OH)₃), talc, and a combination thereof, and a particle diameter of the sheet-shaped inorganic particle is about 0.1 μm to about 10 μm.

### CROSS-REFERENCE TO RELATED APPLICATION

This application claims priority to and the benefit of Korean Patent Application No. 10-2017-0101746 filed in the Korean Intellectual Property Office on Aug. 10, 2017, the entire content of which is incorporated herein by reference.

### BACKGROUND

### 1. Field

Aspects of embodiments of the present disclosure are directed to a separator for a rechargeable battery and a rechargeable lithium battery including the same.

### 2. Description of the Related Art

A separator for an electrochemical battery is an intermediate film (e.g., a layer located between other parts) that separates a positive electrode and a negative electrode in the battery, and continuously maintains ion conductivity in order to enable charging and discharging of the battery.

With increasing development of and demand for vehicle-mounted rechargeable lithium batteries, improvements in battery capacity, current density, and safety have become increasingly desired. In addition, since it is desirable that such batteries are not easily penetrated by a sharp object and not easily ignited even when penetrated at a high temperature, separators having improved penetration characteristics are desired.

### SUMMARY

One or more aspects of example embodiments of the present disclosure provide for a separator for a rechargeable battery having high heat resistance and strong adherence, as well as a rechargeable lithium battery including the same and having improved heat resistance, stability, cycle-life characteristics, rate capability, oxidation resistance, and the like.

In addition, one or more aspects of example embodiments of the present disclosure provide for a separator having high heat-resistance puncture strength and a low thermal shrinkage rate that is capable of improving the penetration characteristics of a battery, as well as a rechargeable lithium battery having improved penetration characteristics, stability, cycle-life characteristics, and the like.

In one or more embodiments, a separator for a rechargeable battery includes a porous substrate and a heat resistance layer on at least one surface of the porous substrate, wherein the heat resistance layer includes an acryl-based copolymer, a polyvinyl alcohol-based polymer, and a sheet-shaped inorganic particle. The sheet-shaped inorganic particle may be selected from mica, clay, magnesium hydroxide (Mg(OH)₂), aluminum hydroxide (Al(OH)₃), talc, and a combination thereof, and a particle diameter of the sheet-shaped inorganic particle may be about 0.1 μm to about 10 μm.

In one or more embodiments, a rechargeable lithium battery includes a positive electrode, a negative electrode, and the separator for a rechargeable battery between the positive electrode and the negative electrode.

The separator for a rechargeable battery according to an embodiment of the present disclosure shows excellent heat resistance, adherence, high heat-resistance puncture strength, and a low thermal shrinkage rate; and the rechargeable lithium battery including the same shows excellent heat resistance, stability, cycle-life characteristics, rate capability, oxidation resistance, penetration characteristics, and the like.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a cross-sectional view showing a separator for a rechargeable battery according to an embodiment of the present disclosure.

FIG. 2 is an exploded perspective view showing a rechargeable lithium battery according to an embodiment of the present disclosure.

### DETAILED DESCRIPTION

Hereinafter, embodiments of the present invention are described in more detail with reference to example embodiments. The disclosure may, however, be embodied in many different forms and should not be construed as being limited to the embodiments set forth herein; rather, the embodiments are provided so that this disclosure will be thorough and complete, and will fully convey the subject matter of the disclosure to those skilled in the art. Features of embodiments of the present disclosure and how to achieve them will become apparent by reference to the embodiments described in detail herein, together with the accompanying drawings. This disclosure may, however, be embodied in many different forms and should not be limited to the example embodiments.

Hereinafter, embodiments may be described by referring to the attached drawings, where like reference numerals denote like elements, and duplicative explanations thereof may not be provided.

As used herein, the terms as “first”, “second”, etc., are used only to distinguish one component from another, and such components should not be limited by these terms. As used herein, the singular forms “a,” “an” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components. Expressions such as “at least one of”, “one of”, “at least one selected from”, and “one selected from”, when preceding a list of elements, modify the entire list of elements and do not modify the individual elements of the list.

It will be understood that when a layer, film, region, or plate is referred to as being “on” another layer, film, region, or plate, unless otherwise stated, the layer, film, region, or plate may be directly or indirectly formed on the other layer, film, region, or plate. For example, intervening layers, films, regions, or plates may be present in some embodiments. In some embodiments, the sizes of components in the drawings may be exaggerated for convenience of explanation. In other words, since sizes and thicknesses of components in the drawings are arbitrarily illustrated for convenience of explanation, the following embodiments of the present disclosure are not limited thereto.

When a definition is not otherwise provided, the term “substituted” as used herein refers to replacement of a hydrogen atom with a substituent (group) selected from a C1 to C30 alkyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen atom (F, C1, Br, and/or I), a hydroxy group (—OH), a nitro group (—NO₂), a cyano group (—CN), an amino group (—NRR′, wherein R and R′ are each independently hydrogen or a C1 to C6 alkyl group), a sulfobetaine group (—RR′N⁺(CH₂)ₙSO₃⁻), a carboxyl betaine group (—RR′N⁺(CH₂)ₙCOO⁻, wherein R and R′ are each independently a C1 to C20 alkyl group), an azido group (—N₃), an amidino group (—C(═NH)NH₂), a hydrazino group (—NHNH₂), a hydrazono group (═N(NH₂), an aldehyde group (—C(═O)H), a carbamoyl group (—C(O)NH₂), a thiol group (—SH), an ester group (—C(═O)OR, wherein R is a C1 to C6 alkyl group or a C6 to C12 aryl group), a carboxyl group (—COOH) or a salt thereof (—C(═O)OM, wherein M is an organic or inorganic cation), a sulfonic acid group (—SO₃H) or a salt thereof (—SO₃M, wherein M is an organic or inorganic cation), a phosphoric acid group (—PO₃H₂) or a salt thereof (—PO₃MH or —PO₃M₂, wherein M is an organic or inorganic cation), and a combination thereof.

Hereinafter, a C1 to C3 alkyl group may be a methyl group, an ethyl group, or a propyl group. A C1 to C10 alkylene group may be, for example, a C1 to C6 alkylene group, a C1 to C5 alkylene group, or a C1 to C3 alkylene group, and may be, for example, a methylene group, an ethylene group, or a propylene group. A C3 to C20 cycloalkylene group may be, for example, a C3 to C10 cycloalkylene group or a C5 to C10 alkylene group, and may be, for example, a cyclohexylene group. A C6 to C20 arylene group may be, for example, a C6 to C10 arylene group and may be, for example, a benzylene group or a phenylene group. A C3 to C20 heterocyclic group may be, for example, a C3 to C10 heterocyclic group and may be, for example, a pyridine group.

Hereinafter, the term “hetero” refers to inclusion of at least one heteroatom selected from nitrogen (N), oxygen (O), sulfur (S), silicon (Si), and phosphorus (P).

Hereinafter, the term “combination thereof” may refer to a mixture, a copolymer, a blend, an alloy, a composite, and/or a reaction product of two or more components.

In addition, in the chemical formulae, “*” refers to a point of attachment to an atom, a group, or a unit that may be the same or different as that depicted in the formula.

Hereinafter, the term “alkali metal” refers to an element belonging to Group 1 of the periodic table, for example, lithium (Li), sodium (Na), potassium (K), rubidium (Ru), cesium (Cs), or francium (Fr). The alkali metal element may be present in a cationic state or a neutral state.

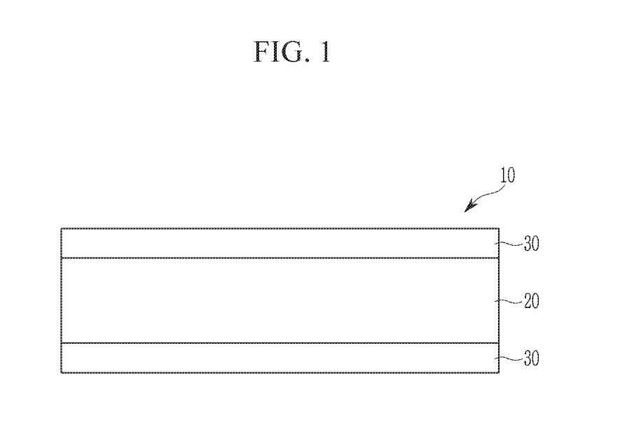

Hereinafter, a separator for a rechargeable battery is described with reference to FIG. 1. FIG. 1 is a cross-sectional view showing a separator for a rechargeable battery according to an embodiment of the present disclosure. Referring to FIG. 1, a separator 10 for a rechargeable battery according to an embodiment of the present disclosure includes a porous substrate 20 and a heat resistance layer 30 positioned on one surface or both (e.g., opposing) surfaces of the porous substrate 20. FIG. 1 illustrates heat resistance layers 30 on both surfaces of the porous substrate 20. However, the heat resistance layer 30 may be on one surface of the porous substrate 20, without limitation.

The porous substrate 20 may have a plurality of pores, and may generally be a porous substrate used in an electrochemical device. The porous substrate 20 may be a polymer film formed of a polymer, or a copolymer or mixture of two or more polymers selected from a polyolefin (such as polyethylene, polypropylene, and the like), a polyester (such as polyethylene terephthalate, polybutylene terephthalate, and the like), polyacetal, polyamide, polyimide, polycarbonate, polyetheretherketone, polyaryletherketone, polyetherimide, polyamideimide, polybenzimidazole, polyether sulfone, polyphenylene oxide, a cyclic olefin copolymer, polyphenylene sulfide, polyethylene naphthalate, a glass fiber, and Teflon® (e.g., polytetrafluoroethylene).

In some embodiments, the porous substrate 20 may be, for example, a polyolefin-based substrate, and the polyolefin-based substrate may improve battery safety because of its improved shut-down function. In some embodiments, the polyolefin-based substrate may be, for example, selected from a polyethylene single film, a polypropylene single film, a polyethylene/polypropylene double film, a polypropylene/polyethylene/polypropylene triple film, and a polyethylene/polypropylene/polyethylene triple film. In addition, the polyolefin-based resin may include a non-olefin resin in addition to an olefin resin, or a copolymer of olefin and a non-olefin monomer.

The porous substrate 20 may have a thickness of about 1 μm to about 40 μm, for example, about 1 μm to about 30 μm, or about 1 μm to about 20 μm. When the porous substrate 20 has a thickness of about 1 μm to about 10 μm or about 5 to about 10 μm, the separator may be formed as a thin film, and when the porous substrate 20 has a thickness of about 10 μm to about 20 μm, the separator may have excellent hardness and heat resistance, and may thus be applied to a vehicle-mounted battery.

The heat resistance layer 30 may include an acryl-based copolymer, a polyvinyl alcohol-based polymer, and a sheet-shaped inorganic particle.

The acryl-based copolymer may include a unit derived from (meth)acrylate or (meth)acrylic acid, a cyano group-containing unit, and/or a sulfonate group-containing unit. The acryl-based copolymer may aid in fixing the sheet-shaped inorganic particle on or to the porous substrate 20, and may concurrently (e.g., simultaneously or at the same time) provide an adhesion force to adhere the heat resistance layer 30 on the porous substrate 20 and the electrode, and may contribute to the improvement of heat resistance, air permeability, and/or oxidation resistance of the separator 10.

In the unit derived from (meth)acrylate or (meth)acrylic acid, the (meth)acrylate may be a conjugate base of a (meth)acrylic acid, a (meth)acrylate salt, or a derivative thereof. In some embodiments, the unit derived from (meth)acrylate or (meth)acrylic acid may be represented by Chemical Formula 1, Chemical Formula 2, Chemical Formula 3, or a combination thereof:

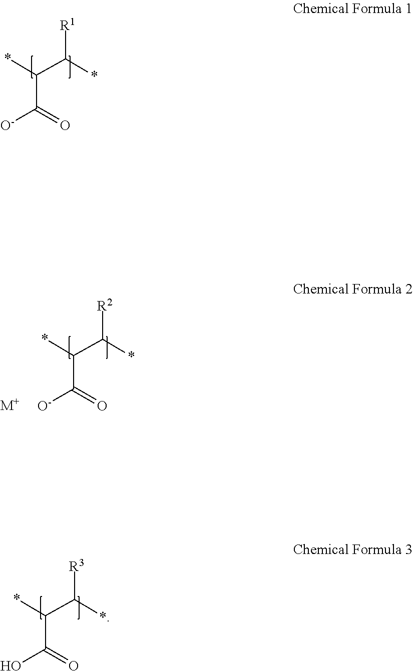

In Chemical Formula 1 to Chemical Formula 3, R¹, R² and R³ may each independently be hydrogen or a methyl group, and in Chemical Formula 2, M may be an alkali metal. In some embodiments, the alkali metal may be, for example, lithium (Li), sodium (Na), potassium (K), rubidium (Rb), or cesium (Cs).

For example, the unit derived from (meth)acrylate or (meth)acrylic acid may include the unit represented by Chemical Formula 2 and the unit represented by Chemical Formula 3. In this case, the unit represented by Chemical Formula 2 and the unit represented by Chemical Formula 3 may be included in a mole ratio of about 10:1 to about 1:2, or about 10:1 to about 1:1, or about 5:1 to about 1:1.

The unit derived from (meth)acrylate or (meth)acrylic acid may be included in an amount of about 10 mol % to about 70 mol % based on an amount of the acryl-based copolymer, for example about 20 mol % to about 60 mol %, about 30 mol % to about 60 mol %, or about 40 mol % to about 55 mol % based on the amount of the acryl-based copolymer. When the unit is included within these ranges, the acryl-based copolymer and the separator including the same may exhibit excellent adherence, heat resistance, air permeability, and oxidation resistance.

In some embodiments, the cyano group-containing unit may be, for example, represented by Chemical Formula 4:

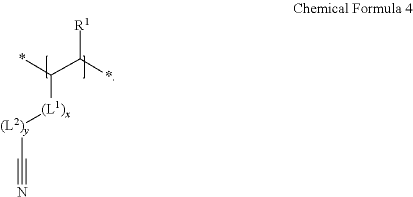

In Chemical Formula 4, R⁴ may be a hydrogen atom or a C1 to C3 alkyl group, L¹ may be —C(═O)—, —C(═O)O—, —OC(═O)—, —O—, or —C(═O)NH—, L² may be a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, x may be an integer from 0 to 2, and y may be an integer from 0 to 2.

In some embodiments, the cyano group-containing unit may be, for example, a unit derived from (meth)acrylonitrile, alkenenitrile, cyanoalkyl(meth)acrylate, or 2-(vinyloxy)alkane nitrile. Herein, the alkene may be a C1 to C20 alkene group, a C1 to C10 alkene group, or a C1 to C6 alkene group; the alkyl may be a C1 to C20 alkyl group, a C1 to C10 alkyl group, or a C1 to C6 alkyl group; and the alkane may be a C1 to C20 alkane group, a C1 to C10 alkane group, or a C1 to C6 alkane group.

Non-limiting examples of the alkene nitrile include allyl cyanide, 4-pentene nitrile, 3-pentene nitrile, 2-pentene nitrile, 5-hexene nitrile, and the like. Non-limiting examples of the cyanoalkyl(meth)acrylate include cyanomethyl(meth)acrylate, cyanoethyl(meth)acrylate, cyanopropyl(meth)acrylate, and cyanooctyl(meth)acrylate. Non-limiting examples of the 2-(vinyloxy)alkane nitrile include 2-(vinyloxy)ethane nitrile and 2-(vinyloxy)propane nitrile.

The cyano group-containing unit may be included in an amount of about 30 mol % to about 85 mol % based on a total amount of the acryl-based copolymer, for example, about 30 mol % to about 70 mol %, about 30 mol % to about 60 mol %, or about 35 mol % to about 55 mol % based on the total amount of the acryl-based copolymer. When the cyano group-containing unit is included within these ranges, the acryl-based copolymer and the separator 10 including the same may exhibit excellent oxidation resistance, adherence, heat resistance, and/or air permeability.

The sulfonate group-containing unit may be a unit including a conjugate base of a sulfonic acid, a sulfonate salt, a sulfonic acid, or a derivative thereof. In some embodiments, the sulfonate group-containing unit may be represented by Chemical Formula 5, Chemical Formula 6, Chemical Formula 7 or a combination thereof:

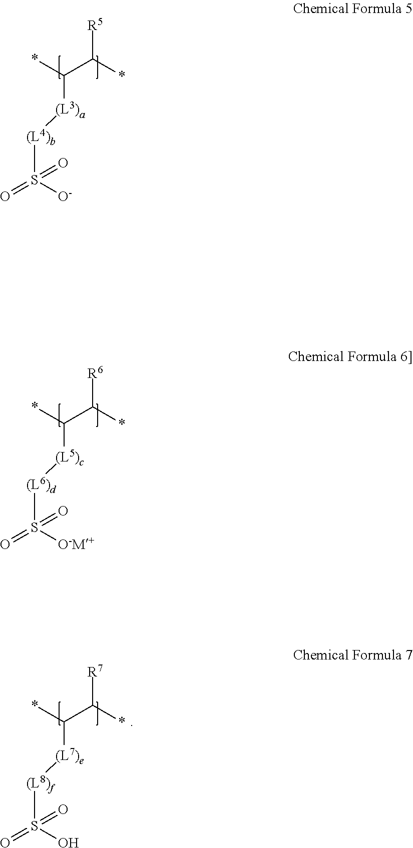

In Chemical Formula 5 to Chemical Formula 7, R⁵, R⁶, and R⁷ may each independently be a hydrogen atom or a C1 to C3 alkyl group; L³, L⁵, and L⁷ may each independently be —C(═O)—, —C(═O)O—, —OC(═O)—, —O—, or —C(═O)NH—; L⁴, L⁶, and L⁸ may each independently be a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group; a, b, c, d, e, and f may each independently be an integer from 0 to 2; and in Chemical Formula 6, M′ may be an alkali metal.

For example, in Chemical Formula 5 to Chemical Formula 7, L³, L⁵, and L⁷ may each independently be —C(═O)NH—; L⁴, L⁶, and L⁸ may each independently be a C1 to C10 alkylene group; and a, b, c, d, e, and f may each be 1.

The sulfonate group-containing unit may include one of a unit represented by Chemical Formula 5, a unit represented by Chemical Formula 6, and a unit represented by Chemical Formula 7; or may include a combination of at least two thereof. For example, the sulfonate group-containing unit may include a unit represented by Chemical Formula 6. As another example, the sulfonate group-containing unit may include a unit represented by Chemical Formula 6 and a unit represented by Chemical Formula 7.

In some embodiments, the sulfonate group-containing unit may be a unit derived from vinyl sulfonic acid, allyl sulfonic acid, styrene sulfonic acid, anethole sulfonic acid, acryl amidoalkane sulfonic acid, sulfoalkyl (meth)acrylate, or a salt thereof.

Herein, the alkane may be a C1 to C20 alkane group, a C1 to C10 alkane group, or a C1 to C6 alkane group, and the alkyl may be a C1 to C20 alkyl group, a C1 to C10 alkyl group, or a C1 to C6 alkyl group. The salt may include (e.g., consist) of a charged form of the sulfonic acid and a suitable or appropriate ion. In some embodiments, the ion may be an alkali metal ion, and the salt may be an alkali metal sulfonate salt.

In some embodiments, the acryl amidoalkane sulfonic acid may be, for example, 2-acrylamido-2-methylpropane sulfonic acid, and the sulfoalkyl (meth)acrylate may be, for example, 2-sulfoethyl (meth)acrylate, 3-sulfopropyl (meth)acrylate, or the like.

The sulfonate group-containing unit may be included in an amount of about 0.1 mol % to about 20 mol % % based on a total amount of the acryl-based copolymer, for example, about 0.1 mol % to about 10 mol %, about 1 mol % to about 20 mol %, or about 1 mol % to about 10 mol % based on the total amount of the acryl-based copolymer. When the sulfonate group-containing unit is included within these ranges, the acryl-based copolymer and the separator 10 including the same may exhibit improved adherence, heat resistance, air permeability, and/or oxidation resistance.

In some embodiments, the acryl-based copolymer may be, for example, represented by Chemical Formula 11:

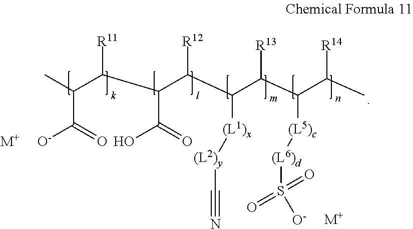

In Chemical Formula 11, R¹¹ and R¹² may each independently be a hydrogen atom or a methyl group; R¹³ and R¹⁴ may each independently be a hydrogen atom or a C1 to C3 alkyl group; L¹ and L⁵ may each independently be —C(═O)—, —C(═O)O—, —OC(═O)—, —O—, or —C(═O)NH—; L² and L⁶ may each independently be a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group; x, y, c, and d may each independently be an integer from 0 to 2; M may be an alkali metal of lithium, sodium, potassium, rubidium, or cesium; and k, l, m, and n may each denote a mole ratio of each unit.

In some embodiments, for example, in Chemical Formula 11, k+l+m+n=1. In some embodiments, 0.1≤(k+l)≤0.5, 0.4≤m≤0.85 and 0.001≤n≤0.2, or for example, 0.1≤k≤0.5 and 0≤l≤0.25.

In some embodiments, in Chemical Formula 11, x=y=0, L⁵ is —C(═O)NH—, L⁶ is a C1 to C10 alkylene group, and c=d=1.

In the acryl-based copolymer, a substitution degree of the alkali metal (M⁺) may be about 0.5 to about 1.0, for example about 0.6 to about 0.9, or about 0.7 to about 0.9 relative to (k+n). When the substitution degree of the alkali metal satisfies these ranges, the acryl-based copolymer and the separator 10 including the same may exhibit excellent adherence, heat resistance, and/or oxidation resistance.

The acryl-based copolymer may further include other units in addition to the above units. For example, the acryl-based copolymer may further include a unit derived from alkyl(meth)acrylate, a unit derived from a diene-based monomer, a unit derived from a styrene-based monomer, an ester group-containing unit, a carbonate group-containing unit, or a combination thereof.

The acryl-based copolymer may have various forms. For example, the acryl-based copolymer may be an alternate polymer where the units are alternately distributed, a random polymer where the units are randomly distributed, or a graft polymer where a part of unit is grafted.

A weight average molecular weight of the acryl-based copolymer may be about 200,000 g/mol to about 700,000 g/mol, for example, about 200,000 g/mol to about 600,000 g/mol, or about 300,000 g/mol to about 700,000 g/mol. When the weight average molecular weight of the acryl-based copolymer satisfies these ranges, the acryl-based copolymer and the separator 10 including the same may exhibit excellent adherence, heat resistance, air permeability, and/or oxidation resistance. The weight average molecular weight may be the polystyrene-reduced average molecular weight, as measured by gel permeation chromatography (GPC).

A glass transition temperature of the acryl-based copolymer may be about 200° C. to about 280° C., for example, about 210° C. to about 270° C., or about 210° C. to about 260° C. When the glass transition temperature of the acryl-based copolymer satisfies these ranges, the acryl-based copolymer and the separator 10 including the same may exhibit excellent adherence, heat resistance, air permeability, and/or oxidation resistance. The glass transition temperature may be measured by differential scanning calorimetry (DSC).

The acryl-based copolymer may be prepared using any suitable method, such as emulsion polymerization, suspension polymerization, massive polymerization, solution polymerization, and/or bulk polymerization.

The acryl-based copolymer may be included in an amount of about 1 wt % to about 30 wt % based on a total weight of the heat resistance layer 30, for example, about 1 wt % to about 20 wt %, about 1 wt % to about 15 wt %, or about 1 wt % to about 10 wt % based on the total weight of the heat resistance layer 30. When the acryl-based copolymer is included in the heat resistance layer 30 within these ranges, the separator 10 may exhibit excellent heat resistance, adherence, air permeability, and/or oxidation resistance.

The heat resistance layer 30 according to an embodiment of the present disclosure may include a polyvinyl alcohol-based polymer. The polyvinyl alcohol-based polymer may be included in an amount of about 0.01 wt % to about 0.03 wt % based on a total weight of the heat resistance layer 30. When the polyvinyl alcohol-based polymer is included in this range, bonding of the heat resistance layer 30 with the porous substrate 20 may be reinforced, thereby suppressing or reducing contraction of the separator under a high temperature environment and reducing the chance of a short circuit.

The polyvinyl alcohol-based polymer may be a polymer including a repeating unit having an (—OH) functional group or a polyvinyl alcohol having an (—OH) functional group partially modified to include a functional group such as a carboxyl group, a sulfonic acid group, an amino group, a silanol group, a thiol group, and/or the like.

The heat resistance layer 30 according to an embodiment of the present disclosure includes sheet-shaped (plate-shaped) inorganic particles for improved heat resistance and may thus prevent or reduce sharp contraction or transformation of a separator under increased temperatures. In addition, the separator 10 including this heat resistance layer 30 may have high heat resistance, and thus may be protected from contracting under high temperatures. The separator 10 including this heat resistance layer 30 may also be protected from being melted or cracked and may have high puncture strength and ductility at a temperature greater than or equal to about 200° C. When the separator is included in a battery, the penetration characteristics of the battery may be improved, and the battery may be protected from ignition or sparking upon penetration, thereby securing the safety of the battery.

According to an embodiment of the present disclosure, when inorganic particles having a sheet shape instead of a sphere shape or the like are applied to the heat resistance layer 30, a thermal shrinkage rate of the separator 10 may be sharply decreased at a temperature greater than or equal to about 200° C. or 250° C. Furthermore, the heat-resistance puncture strength may be improved while a low hardness and Young's modulus are maintained, and as a result, battery penetration characteristics may be remarkably improved without destroying the separator 10.

In some embodiments, the sheet-shaped inorganic particles may be, for example, endothermic and may further improve the heat resistance of the separator and penetration characteristics of a battery.

In some embodiments, the sheet-shaped inorganic particles may include, for example, at least one selected from mica, clay, magnesium hydroxide (Mg(OH)₂), aluminum hydroxide (Al(OH)₃), talc, and a combination thereof.

The sheet-shaped inorganic particles may have a particle diameter of about 0.1 μm to about 10 μm, for example, about 0.1 μm to about 8 μm, or about 1 μm to about 5 μm. When the sheet-shaped inorganic particles having a particle diameter within these ranges are used, the separator may show excellent heat resistance and penetration characteristics, as well as suitable or appropriate air permeability. The term “particle diameter” may refer to the average particle diameter, e.g., the particle size D₅₀ at a volume ratio of 50% in a cumulative size-distribution curve. The particle diameter may be measured using a particle size analyzer (Ex.: Bluewave made by Microtrac, Montgomeryville, Pa.).

An average thickness of the sheet-shaped inorganic particle may be about 10 nm to about 500 nm, for example, about 20 nm to about 300 nm, or about 50 nm to about 200 nm. When these inorganic particles are used, the separator may have improved heat resistance, penetration characteristics, and the like, and may maintain desirable properties such as a suitable or appropriate thickness, air permeability, and/or the like.

A specific surface area of the sheet-shaped inorganic particle may be about 1 m²/g to about 50 m²/g, for example, about 2 m²/g to about 30 m²/g. When the sheet-shaped inorganic particles have a specific surface area within these ranges, the separator may exhibit desirable properties such as suitable or appropriate air permeability and/or the like.

In some embodiments, the sheet-shaped inorganic particles may be, for example, surface-treated with a surfactant, a fatty acid, a silane, and/or the like so that the particles are oleophilic (e.g., lipophilic). The sheet-shaped inorganic particles may be well mixed with a binder, and may thus be more easily processed.

The sheet-shaped inorganic particle may be included in an amount of about 50 wt % to about 99 wt % based on a total weight of the heat resistance layer, for example, about 70 wt % to about 99 wt %, about 75 wt % to about 99 wt %, about 80 wt % to about 99 wt %, about 85 wt % to about 99 wt %, about 90 wt % to about 99 wt %, or about 95 wt % to about 99 wt % based on the total weight of the heat resistance layer. When the sheet-shaped inorganic particles are included within these ranges in the heat resistance layer 30, the hardness and elastic modulus of the heat resistance layer 30 after exposure to high temperature may be increased, the heat-resistance puncture strength of the separator 10 including the heat resistance layer 30 may be improved, a thermal shrinkage rate at high temperature may be decreased, and the penetration characteristics and/or the like may be improved. Accordingly, the separator may exhibit excellent heat resistance, durability, oxidation resistance, and/or stability.

In some embodiments, the heat resistance layer 30 may further include a cross-linkable binder having a cross-linking structure in addition to the acryl-based copolymer. The cross-linkable binder may be obtained from a monomer, an oligomer, and/or a polymer having a curable functional group capable of reacting with heat and/or light, for example, a multi-functional monomer, a multi-functional oligomer, and/or a multi-functional polymer having at least two curable functional groups. The curable functional group may include a vinyl group, a (meth)acrylate group, an epoxy group, an oxetane group, an ether group, a cyanate group, an isocyanate group, a hydroxy group, a carboxyl group, a thiol group, an amino group, an alkoxy group, or a combination thereof, but embodiments of the present disclosure are not limited thereto.

The cross-linkable binder may be obtained from a monomer, an oligomer and/or a polymer including at least two (meth)acrylate groups, for example, ethylene glycol di(meth)acrylate, propylene glycol di(meth)acrylate, polyethylene glycol di(meth)acrylate, polypropylene glycol di(meth)acrylate, butanediol di(meth)acrylate, hexamethylene glycol di(meth)acrylate, trimethylolpropane tri(meth)acrylate, glycerine tri(meth)acrylate, pentaerythritol tetra(meth)acrylate, diglycerine hexa(meth)acrylate, or a combination thereof.

In some embodiments, the cross-linkable binder may be obtained from a monomer, an oligomer and/or a polymer including at least two epoxy groups, for example, bisphenol A diglycidyl ether, bisphenol F diglycidyl ether, hexahydrophthalic acid glycidyl ester, or a combination thereof.

In some embodiments, the cross-linkable binder may be obtained from a monomer, an oligomer and/or a polymer including at least two isocyanate groups, for example diphenylmethane diisocyanate, 1,6-hexamethylene diisocyanate, 2,2,4(2,2,4)-trimethyl hexamethylene diisocyanate, phenylene diisocyanate, 4,4′-dicyclohexylmethane diisocyanate, 3,3′-dimethyldiphenyl-4,4′-diisocyanate, xylene diisocyanate, naphthalene diisocyanate, 1,4-cyclohexyl diisocyanate, or a combination thereof.

In addition, the heat resistance layer 30 may further include a non-cross-linkable binder in addition to the acryl-based copolymer. In some embodiments, the non-cross-linkable binder may be, for example, a vinylidene fluoride-based polymer, polymethylmethacrylate, polyacrylonitrile, polyvinylpyrrolidone, polyvinylacetate, a polyethylene-vinylacetate copolymer, polyethyleneoxide, cellulose acetate, cellulose acetate butyrate, cellulose acetate propionate, cyanoethyl pullulan, cyanoethylpolyvinyl alcohol, cyanoethyl cellulose, cyanoethylsucrose, pullulan, carboxylmethyl cellulose, an acrylonitrile-styrene-butadiene copolymer, or a combination thereof, but embodiments of the present disclosure are not limited thereto.

In some embodiments, the vinylidene fluoride-based polymer may be a homopolymer including only a vinylidene fluoride monomer-derived cross-linkable binder or a copolymer of a vinylidene fluoride-derived cross-linkable binder and another monomer-derived cross-linkable binder. In some embodiments, the copolymer may include a vinylidene fluoride-derived cross-linkable binder and at least one cross-linkable binder derived from chlorotrifluoroethylene, trifluoroethylene, hexafluoropropylene, ethylene tetrafluoride and/or ethylene monomers, but embodiments of the present disclosure are not limited thereto. For example, the copolymer may be a polyvinylidene fluoride-hexafluoropropylene (PVdF-HFP) copolymer including a vinylidene fluoride monomer-derived cross-linkable binder and a hexafluoropropylene monomer-derived cross-linkable binder.

For example, the non-cross-linkable binder may be a polyvinylidene fluoride (PVdF) homopolymer, a polyvinylidene fluoride-hexafluoropropylene (PVdF-HFP) copolymer, or a combination thereof. When the non-cross-linkable binder is selected from these materials, adherence between the porous substrate 20 and the heat resistance layer 30 is increased, the stabilities of the separator 10 and impregnation properties of an electrolyte solution are improved, and the high-rate charge and discharge characteristics of a battery are improved.

The heat resistance layer 30 may have a thickness of about 0.01 μm to about 20 μm, for example, about 1 μm to about 10 μm, about 1 μm to about 5 μm, or about 1 μm to about 3 μm.

A ratio of a thickness of the heat resistance layer 30 to a thickness of the porous substrate 20 may be about 0.05 to about 0.5, for example, about 0.05 to about 0.4, about 0.05 to about 0.3, or about 0.1 to about 0.2. When the ratio is within these ranges, the separator 10 including the porous substrate 20 and the heat resistance layer 30 may exhibit excellent air permeability, heat resistance, and/or adherence.

The separator 10 for a rechargeable battery according to an embodiment of the present disclosure may have excellent heat resistance. In some embodiments, the separator 10 may have a shrinkage rate of less than or equal to about 5%, for example, less than or equal to about 4%. For example, after the separator 10 is allowed to stand at about 150° C. for about 60 minutes, the shrinkage rate of the separator 10 may be less than or equal to about 5%, or less than or equal to about 4% in a machine direction (MD) and in a transverse direction (TD).

In general, when the heat resistance layer 30 is thick, the shrinkage rate of the separator 10 at high temperature may be lowered. However, the separator 10 according to an embodiment of the present disclosure may realize a high temperature shrinkage rate of less than or equal to about 5% even when a thickness of the heat resistance layer 30 is about 1 μm to about 5 μm, or about 1 μm to about 3 μm.

In addition, the separator 10 for a rechargeable battery according to an embodiment of the present disclosure may resist breakage and/or deformation, and may maintain a stable shape at a high temperature of greater than or equal to about 200° C., for example, about 200° C. to about 250° C.

The separator 10 for a rechargeable battery according to an embodiment of the present disclosure may exhibit excellent air permeability, for example, an air permeability of less than about 200 sec/100 cc, less than or equal to about 190 sec/100 cc, or less than or equal to about 180 sec/100 cc for a thickness of e.g., about 5 μm. In other words, the separator may have an air permeability of less than about 40 sec/100 cc·1 μm, for example less than or equal to about 38 sec/100 cc·1 μm, or less than or equal to about 36 sec/100 cc·1 μm per a unit thickness. Herein, the term “air permeability” refers to the time (in seconds) it takes for the separator to pass 100 cc of air.

The separator 10 for a rechargeable battery according to an embodiment of the present disclosure may be manufactured using any suitable method available in the art. For example, the separator 10 for a rechargeable battery may be manufactured by coating a composition for forming a heat resistance layer on one surface or both surfaces of the porous substrate 20 and drying it.

The composition for forming the heat resistance layer may include the acryl-based copolymer, the polyvinyl alcohol-based polymer, the sheet-shaped inorganic particle, and a solvent.

The solvent is not particularly limited as long as the solvent is able to dissolve or disperse the acryl-based copolymer and the sheet-shaped inorganic particle. In some embodiments, the solvent may be an aqueous solvent including water, an alcohol, or a combination thereof, which is environmentally friendly.

The coating may be achieved by, for example, spin coating, dip coating, bar coating, die coating, slit coating, roll coating, inkjet printing, and/or the like, but embodiments of the present disclosure are not limited thereto.

The drying may be achieved by, for example, natural drying; drying with warm air, hot air, and/or low humid air; vacuum-drying; and/or irradiating with a far-infrared ray, an electron beam, and/or the like, but embodiments of the present disclosure are not limited thereto. In some embodiments, the drying may be, for example, performed at a temperature of about 25° C. to about 120° C.

The separator 10 for a rechargeable battery may be manufactured by lamination, coextrusion, and/or the like, in addition to the above methods.

Hereinafter, a rechargeable lithium battery including the separator 10 for a rechargeable battery is described.

A rechargeable lithium battery may be classified by the type or kind of separator and electrolyte included therein, e.g., as a lithium ion battery, a lithium ion polymer battery, or a lithium polymer battery, etc. The battery may also be classified by shape, e.g., as cylindrical, prismatic, coin-type, pouch-type, and/or the like. In addition, the battery may be classified by size, e.g., as being a bulk type or a thin film type. Any suitable structures and manufacturing methods available in the art for lithium ion batteries may be used.

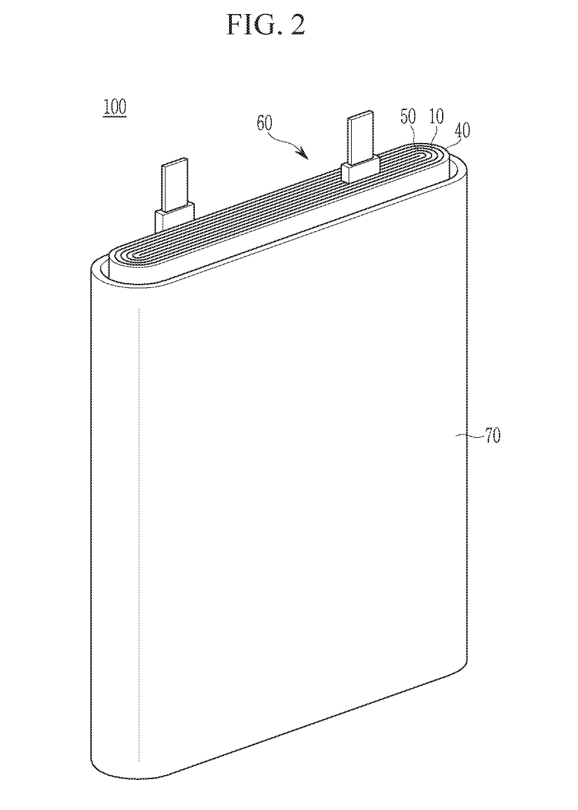

Herein, as an example of a rechargeable lithium battery, a prismatic rechargeable lithium battery is described. FIG. 2 is an exploded perspective view showing a rechargeable lithium battery according to an embodiment of the present disclosure. Referring to FIG. 2, a rechargeable lithium battery 100 according to an embodiment of the present disclosure includes an electrode assembly 60 manufactured by interposing a separator 10 between a positive electrode 40 and a negative electrode 50 and winding them, and a case 70 housing the electrode assembly 60.

The electrode assembly 60 may have, for example, a jelly-roll shape formed by winding the positive electrode 40, the negative electrode 50, and the separator 10 therebetween.

The positive electrode 40, the negative electrode 50, and the separator 10 may be impregnated with an electrolyte solution.

The positive electrode 40 includes a positive current collector and a positive active material layer formed on the positive current collector. The positive active material layer includes a positive active material, a binder, and optionally a conductive material.

The positive current collector may be formed of aluminum, nickel, and/or the like, but embodiments of the present disclosure are not limited thereto.

The positive active material may be a compound capable of intercalating and deintercalating lithium ions. In some embodiments, at least one of a lithium composite oxide or a lithium composite phosphate of a metal selected from cobalt, manganese, nickel, aluminum, iron, or a combination thereof may be used. For example, the positive active material may be a lithium cobalt oxide, a lithium nickel oxide, a lithium manganese oxide, a lithium nickel cobalt manganese oxide, a lithium nickel cobalt aluminum oxide, a lithium iron phosphate, or a combination thereof.

The binder may improve binding between positive active material particles and with the current collector. Non-limiting examples of suitable binders include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, nylon, and/or the like. The binder may be a single binder, or a combination of two or more.

The conductive material may improve the conductivity of the electrode. Non-limiting examples thereof include natural graphite, artificial graphite, carbon black, carbon fibers, a metal powder, metal fibers, and/or the like. The conductive material may be a single material, or a combination of two or more. The metal in the metal powder and/or the metal fiber may include copper, nickel, aluminum, silver, and/or the like.

The negative electrode 50 may include a negative current collector and a negative active material layer formed on the negative current collector.

The negative current collector may include copper, gold, nickel, a copper alloy, and/or the like, but embodiments of the present disclosure are not limited thereto.

The negative active material layer may include a negative active material, a binder, and optionally a conductive material. The negative active material may be a non-metallic material capable of intercalating and deintercalating lithium ions, a lithium metal, a lithium metal alloy, a material capable of doping and dedoping lithium, a transition metal oxide, or a combination thereof.

The material capable of intercalating and deintercalating lithium ions may be a carbon material, such as any generally used carbon-based negative active material, and non-limiting examples thereof include crystalline carbon, amorphous carbon, and/or a combination thereof. Non-limiting examples of the crystalline carbon include graphite (such as amorphous, sheet-shape, flake, spherical shape and/or fiber-shaped natural graphite or artificial graphite). Non-limiting examples of the amorphous carbon include soft carbon, hard carbon, a mesophase pitch carbonized product, fired coke, and/or the like. The lithium metal alloy may be an alloy of lithium and a metal selected from Na, K, Rb, Cs, Fr, beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), tin (Sn), or a combination thereof. The material capable of doping and dedoping lithium may be Si, SiOₓ (0<x<2), a Si—C composite, a Si—Y alloy, Sn, SnO₂, a Sn—C composite, a Sn—Y alloy, and/or the like, and at least one of these may be mixed with SiO₂. Non-limiting examples of the element Y may be selected from Mg, Ca, Sr, Ba, Ra, Sc, yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), Zn, cadmium (Cd), boron (B), Al, gallium (Ga), Sn, In, thallium (TI), Ge, phosphorus (P), arsenic (As), Sb, bismuth (Bi), sulfur (S), selenium (Se), tellurium (Te), polonium (Po), and a combination thereof. The transition metal oxide may be vanadium oxide, lithium vanadium oxide, and/or the like.

In some embodiments, the binder and the conductive material used in the negative electrode 50 may be the same as the binder and conductive material of the positive electrode 40.

The positive electrode 40 and the negative electrode 50 may each be manufactured by mixing an active material composition (including the active material, a binder, and optionally a conductive material in a solvent), followed by coating the active material composition on a current collector. Herein, the solvent may be N-methylpyrrolidone and/or the like, but embodiments of the present disclosure are not limited thereto. Any suitable electrode manufacturing method available in the art may be used.

The electrolyte solution may include an organic solvent and a lithium salt.

The organic solvent may serve as a medium for transmitting the ions involved in the electrochemical reaction of a battery. Non-limiting examples thereof may include a carbonate-based solvent, an ester-based solvent, an ether-based solvent, a ketone-based solvent, an alcohol-based solvent, and/or an aprotic solvent. The carbonate-based solvent may include dimethyl carbonate, diethyl carbonate, dipropyl carbonate, methylpropyl carbonate, ethylpropyl carbonate, methylethyl carbonate, ethylene carbonate, propylene carbonate, butylene carbonate, and/or the like, and the ester-based solvent may include methyl acetate, ethyl acetate, n-propyl acetate, 1,1-dimethylethyl acetate, methylpropionate, ethylpropionate, γ-butyrolactone, decanolide, valerolactone, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like, and the ketone-based solvent may include cyclohexanone, and the like. The alcohol-based solvent may include ethanol, isopropyl alcohol, and/or the like. The aprotic solvent may include nitriles (such as R—CN, where R is a C2 to C20 linear or branched or cyclic hydrocarbon group and may include a double bond, an aromatic ring, and/or an ether group) and/or the like, amides (such as dimethyl formamide), dioxolanes (such as 1,3-dioxolane, sulfolanes), and/or the like.

The organic solvent may be used alone (e.g., as a single solvent) or in a mixture of two or more, and when the organic solvent is used in a mixture of two or more, the ratio of solvents may be selected in accordance with a desirable cell performance.

The lithium salt is dissolved in the organic solvent to enable operation of the rechargeable lithium battery, supply lithium ions, and improve lithium ion transport between the positive and negative electrodes. Non-limiting examples of the lithium salt may include LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, LiB(C₂O₄)₂, or a combination thereof, but embodiments of the present disclosure are not limited thereto.

The lithium salt may be used at a concentration of about 0.1 M to about 2.0 M. When the lithium salt is included within this concentration range, the electrolyte may have excellent performance and lithium ion mobility due to optimal or good electrolyte conductivity and viscosity.

Hereinafter, the above aspects of the present disclosure are illustrated in more detail with reference to example embodiments. However, these examples are provided only for illustration, and embodiments of the present disclosure are not limited thereto.

### SYNTHESIS EXAMPLE: PREPARATION OF ACRYL-BASED COPOLYMER

### Synthesis Example 1

Distilled water (968 g), acrylic acid (45.00 g, 0.62 mol), ammonium persulfate (0.54 g, 2.39 mmol, 1500 ppm based on monomers), 2-acrylamido-2-methylpropane sulfonic acid (5.00 g, 0.02 mol), and a 5 N sodium hydroxide aqueous solution (0.8 equivalents based on a total amount of the acrylic acid and the 2-acrylamido-2-methylpropane sulfonic acid) were placed in a 3 L four-necked flask equipped with a stirrer, a thermometer, and a condenser. The flask was vacuum-refilled three times with nitrogen after evacuating with a diaphragm pump down to 10 mm Hg, and acrylonitrile (50.00 g, 0.94 mol) was added thereto.

The reaction solution was temperature-controlled between 65° C. to 70° C. and allowed to react for 18 hours. Ammonium persulfate (0.23 g, 1.00 mmol, 630 ppm based on a monomer) was secondarily added thereto, and the resulting mixture was heated up to 80° C. and allowed to react again for 4 hours. The reaction solution was cooled to room temperature and adjusted to have a pH of 7 to 8 using a 25% ammonia aqueous solution.

A poly(acrylic acid-co-acrylonitrile-co-2-acrylamido-2-methylpropane sulfonic acid) sodium salt was prepared using the above method. The acrylic acid, the acrylonitrile, and the 2-acrylamido-2-methylpropane sulfonic acid were used in a mole ratio of 39:59:2. The non-volatile components were quantified in 10 mL of the reaction solution to be about 9.0% (theoretical value: 10%).

### Comparative Synthesis Example 1

An acryl-based copolymer was manufactured according to substantially the same method as Synthesis Example 1 except for using acrylic acid (50 g, 0.69 mol) and acrylonitrile (50 g, 0.94 mol) without 2-acrylamido-2-methylpropane sulfonic acid. The acrylic acid and the acrylonitrile were used in a mole ratio of 42:58. The reaction solution included a non-volatile component at 9.0% (theoretical value: 10%).

### Comparative Synthesis Example 2

An acryl-based copolymer was manufactured according to substantially the same method as Synthesis Example 1 except for using acrylic acid (50 g, 0.69 mol) and 2-acrylamido-2-methylpropane sulfonic acid (50 g, 0.24 mol) without acrylonitrile. The acrylic acid and the acrylamido-2-methylpropane sulfonic acid were used in a mole ratio of 74:26. The reaction solution included a non-volatile component at 9.0% (theoretical value: 10%).

TABLE 1

| | | | | Weight average | Glass |
|---|---|---|---|---|---|
| | Mole ratio of | | | molecular | transition |
| | monomers | | | weight | temperature |
| | AA | AN | AMPS | (g/mol) | (° C.) |
| Synthesis | 39 | 59 | 2 | 310,000 | 280 |
| Example 1 | | | | | |
| Comparative Syn- | 42 | 58 | — | 320,000 | 278 |
| thesis Example 1 | | | | | |
| Comparative Syn- | 74 | — | 26 | 293,000 | 305 |
| thesis Example 2 | | | | | |

The weight average molecular weight and glass transition temperatures for Synthesis Example 1 and Comparative Synthesis Examples 1 and 2 are summarized in Table 1. In Table 1, AA indicates acrylic acid, AN indicates acrylonitrile, and AMPS indicates 2-acrylamido-2-methylpropane sulfonic acid. The glass transition temperature was measured using differential scanning calorimetry (DSC).

### EXAMPLES: MANUFACTURE OF SEPARATOR FOR RECHARGEABLE BATTERY

### Example 1

50 wt % of sheet-shaped Mg(OH)₂ (particle diameter (D₅₀): 0.8 μm, KISUMA5, Kyowa Chemical Industry Co., Ltd., Kagawa, Japan) and 50 wt % of DI water were mixed using a bead mill to prepare an inorganic dispersion. Subsequently, a composition for a heat-resistant layer was prepared to have 45 wt % solid weight by adding water to 0.375 wt % of a polyvinyl alcohol-based polymer (Aquacharge, Sumitomo Seika Chemicals Co., Ltd., Japan), 0.875 wt % of the acryl-based polymer according to Synthesis Example 1, and 43.75 wt % of the inorganic dispersion. The composition was coated to have a 4 μm thick cross section of a polyethylene porous substrate having an average thickness of 14.2 μm (air permeability: 150 sec/100 cc, puncture strength: 360 kgf, Toray Industries, Tokyo, Japan) using a gravure coating method and was then dried at 70° C. for 10 minutes, thereby manufacturing a separator for a rechargeable battery.

### Examples 2 to 5 and Comparative Examples 1 to 6

Additional rechargeable battery separators were manufactured to have the heat-resistant layer compositions and contents shown in Table 2 using substantially the same method as Example 1, according to Examples 2 to 5 and Comparative Examples 1 to 6.

The following inorganic particles were used:

Talc (particle diameter: 1.0 μm, sheet-shaped), KC3000, KOCH Industries Inc. (Wichita, Kans.);

Al₂O₃: (particle diameter: 0.45 μm, spherically-shaped), AES11, Sumitomo Chemical Co., Ltd. (Japan);

SnO₂: (particle diameter: 0.3 μm, spherically-shaped), Nanogetters Inc.; and

MgO: (particle diameter 0.3 μm, spherically-shaped), Nanogetters Inc.

TABLE 2

| | | Polyvinyl | | | | | |
|---|---|---|---|---|---|---|---|
| | Acryl-based | alcohol | | | | | |
| | copolymer | polymer | Inorganic particle (wt %) | | | | |
| | (wt %) | (wt %) | Mg(OH)₂ | Talc | Al₂O₃ | SnO₂ | MgO |
| Example 1 | Synthesis | 0.83 | 97.23 | — | — | — | — |
| | Example 1 | | | | | | |
| | (1.94) | | | | | | |
| Example 2 | Synthesis | 0.83 | — | 97.23 | — | — | — |
| | Example 1 | | | | | | |
| | (1.94) | | | | | | |
| Example 3 | Synthesis | 0.49 | 97.56 | | | | |
| | Example 1 | | | | | | |
| | (1.95) | | | | | | |
| Example 4 | Synthesis | 1.29 | 96.77 | | | | |
| | Example 1 | | | | | | |
| | (1.94) | | | | | | |
| Example 5 | Synthesis | 1.92 | 96.16 | | | | |
| | Example 1 | | | | | | |
| | (1.92) | | | | | | |
| Comparative | Comparative | 0.83 | 97.23 | — | — | — | — |
| Example 1 | Synthesis | | | | | | |
| | Example 1 | | | | | | |
| | (1.94) | | | | | | |
| Comparative | Comparative | 0.83 | 97.23 | — | — | — | — |
| Example 2 | Synthesis | | | | | | |
| | Example 2 | | | | | | |
| | (1.94) | | | | | | |
| Comparative | Synthesis | — | 97.23 | — | — | — | — |
| Example 3 | Example 1 | | | | | | |
| | 2.77 | | | | | | |
| Comparative | Synthesis | 0.83 | — | — | 97.23 | — | — |
| Example 4 | Example 1 | | | | | | |
| | (1.94) | | | | | | |
| Comparative | Synthesis | 0.83 | — | — | — | 97.23 | — |
| Example 5 | Example 1 | | | | | | |
| | (1.94) | | | | | | |
| Comparative | Synthesis | 0.83 | — | — | — | — | 97.23 |
| Example 6 | Example 1 | | | | | | |
| | (1.94) | | | | | | |

### Evaluation

### Evaluation Example 1: Heat-Resistance Puncture Strength

The separators according to Examples 1 to 5 and Comparative Examples 1 to 6 were each cut into a size of 30 cm×7.2 cm and folded to have 8 layers to prepare a sample. Each sample was placed in a forced circulation-type convection oven stabilized at 200° C., allowed to stand for 15 minutes, and taken out. The puncture strength (gf) of the sample was measured using a measuring instrument (KES-G5, KATO Tech Co., Ltd., Kyoto, Japan), and the ten measurements were averaged. This method was used to evaluate the heat-resistance puncture strength of each of the Examples and Comparative Examples, and the results are shown in Table 3.

### Evaluation Example 2: Thermal Shrinkage Rate

The separators according to Examples 1 to 5 and Comparative Examples 1 to 6 were each cut into a size of 10 cm×10 cm, and marked with a first point in a right middle of a vertical direction (MD), as well as two more points 2.5 cm to the right and left of the first point in a horizontal direction (TD). Each sample was placed in a forced circulation-type convection oven stabilized at 200° C. and allowed to stand for 15 minutes therein. Subsequently, the sample was taken out, and the thermal shrinkage rate of the sample was calculated from the length L₀ between second and third points before the heat treatment and a length L₁ between second and third points after the heat treatment according to Calculation Equation 1.

Each sample was allowed to stand at 250° C. for 10 minutes, and then, a thermal shrinkage rate of the sample was separately calculated, and the results are shown in Table 3.

Shrinkage Rate (%)=[(L_{O}−L₁)/L_{O}]×100 Calculation Equation 1

### Evaluation Example 3: Hardness and Young's Modulus of Heat Resistance Layer

Each separator according to Examples 1 to 5 and Comparative Examples 1 to 6 was cut into a size of 10 cm×10 cm and allowed to stand for 10 minutes in a forced circulation-type convection oven stabilized at 200° C. The hardness and Young's modulus of the separator before and after the heat treatment were measured under the following conditions:

Nano Indentation (Park XE7, Park Systems, Suwon, Korea) Process Conditions

Force limit: 3 μN

Up/down speed: 0.1 um/sec

Indentation tip: PPP—NCHR (tip constant: 0.239, Berkovich type)

Force constant: 42 N/m

Calculation method: Oliver and Pharr

Hardness and a modulus were calculated by averaging the results of 25 point indentation per sample, excluding any outliers

Nano Indentation Measurement

1. Indentation was performed in contact mode after scanning separator morphology in an AFM non-contact mode.

2. The calculated modulus and hardness results were obtained by algorithmically revising the tip constant used in the calculated result.

TABLE 3

| | | | | | | Before heat- | | After heat- | |
|---|---|---|---|---|---|---|---|---|---|
| | Heat-resistance | Thermal | | | | resistance test | | resistance test | |
| | puncture | shrinkage rate | | Thermal shrinkage rate | | | Young's | | Young's |
| | strength | (200° C. 15 minutes) | | (250° C. 10 minutes) | | Hardness | modulus | Hardness | modulus |
| | (gf) | MD | TD | MD | TD | (Gpa) | (Gpa) | (Gpa) | (Gpa) |
| Example 1 | 527.1 | 2 | 2 | 2 | 2 | 0.54 | 0.37 | 2.24 | 0.55 |
| Example 2 | 390.0 | 4 | 4 | 4 | 4 | 0.44 | 0.30 | 2.08 | 0.85 |
| Example 3 | 516.5 | 2 | 2 | 2 | 3 | 0.36 | 0.25 | 1.17 | 0.68 |
| Example 4 | 507.6 | 2 | 2 | 2 | 2 | 0.46 | 0.32 | 1.59 | 0.53 |
| Example 5 | 502.7 | 2 | 2 | 2 | 2 | 0.68 | 0.41 | 2.40 | 0.58 |
| Comparative | unmeasurable* | 20 | 25 | ≥50% | ≥50% | 0.50 | 0.36 | unmeasurable | unmeasurable |
| Example 1 | | | | | | | | | |
| Comparative | unmeasurable* | 35 | 40 | ≥50% | ≥50% | 0.48 | 0.37 | unmeasurable | unmeasurable |
| Example 2 | | | | | | | | | |
| Comparative | 60 | 4 | 4 | unmeasurable** | unmeasurable** | 32.7 | 2.8 | 4.83 | 0.50 |
| Example 4 | | | | | | | | | |
| Comparative | 79 | 4 | 4 | unmeasurable** | unmeasurable** | 34.1 | 2.5 | 3.36 | 0.60 |
| Example 5 | | | | | | | | | |
| Comparative | 73 | 4 | 4 | unmeasurable** | unmeasurable** | 33.5 | 2.7 | 4.52 | 0.50 |
| Example 6 | | | | | | | | | |

Referring to Table 3, the separators according to Examples 1 to 5 showed high heat-resistance puncture strength and a very low thermal shrinkage rate of less than or equal to 4% at 200° C. and 250° C. compared with the separators according to Comparative Examples. In addition, the heat resistance layers according to Examples 1 to 5 had low hardness and Young's moduli compared with the heat resistance layer according to Comparative Examples 1, 2, and 4 to 6. After heat exposure testing, the heat resistance layer according to Examples 1 to 5 showed increased hardness and Young's moduli; however, these values were still lower than those for Comparative Examples 1, 2, and 4 to 6. Measurements for Comparative Example 3 were not carried out because the heat resistance layer delaminated from the substrate, and the separator was thus not formed.

* The heat-resistance puncture strength, hardness, and Young's modulus after heat exposure testing of the separators could not be measured for Comparative Examples 1 and 2.

** The samples of Comparative Examples 4, 5, and 6 were melted and destroyed at 250° C. Accordingly, their thermal shrinkage rates could not be measured.

### Preparation Examples 1 to 5 and Comparative Preparation Examples 1 to 6: Manufacture of Rechargeable Lithium Battery Cells

LiCoO₂, polyvinylidene fluoride, and carbon black in a weight ratio of 96:2:2 were added to N-methylpyrrolidone solvent to prepare a slurry. The slurry was coated on an aluminum thin film, dried, and compressed to thereby manufacture a positive electrode.

Graphite, polyvinylidene fluoride, and carbon black in a weight ratio of 98:1:1 were added to N-methylpyrrolidone solvent to prepare a slurry. The slurry was coated on a copper foil, dried, and compressed to thereby manufacture a negative electrode.

The separators according to Examples 1-5 and Comparative Examples 1-6 were respectively interposed between positive and negative electrodes and wound therewith to manufacture jelly-roll type electrode assemblies. An electrolyte solution prepared by mixing ethylene carbonate, ethylmethyl carbonate, and diethyl carbonate in a volume ratio of 3:5:2 and adding 1.15 M LiPF₆ to the mixed solvent was injected into battery cases, and the cases were sealed to manufacture rechargeable lithium battery cells.

### Evaluation Example 4: Penetration Safety Test

The penetration safety of each of the rechargeable lithium battery cells of Preparation Examples 1 to 5 and Comparative Preparation Examples 1 to 6 was evaluated, and the results are shown in Table 4.

Positive and negative electrodes manufactured according to the methods described above were used to manufacture a 1.5 Ah capacity prismatic cell as shown in FIG. 2. A penetration limit evaluation was performed using a 2.5π nail at the penetration speed listed in Table 4.

### Penetration Limit Evaluation Standard

L0: No reaction

L1: Reversible damage on performance of a battery cell

L2: Irreversible damage battery on performance of a battery cell

L3: Less than 50% weight loss of an electrolyte solution of a battery cell

L4: Greater than or equal to 50% weight loss of an electrolyte solution of a battery cell

L5: Ignition or spark (no rupture or explosion)

L6: Battery rupture (no explosion)

L7: Battery explosion

TABLE 4

| | Penetration speed (cm/min) | Cell Penetration |
|---|---|---|
| Preparation Example 1 | 80 | L3 |
| Preparation Example 2 | 80 | L4 |
| Preparation Example 3 | 80 | L3 |
| Preparation Example 4 | 80 | L3 |
| Preparation Example 5 | 80 | L3 |
| Comparative Preparation | 80 | L6 |
| Example 1 | | |
| Comparative Preparation | 80 | L6 |
| Example 2 | | |
| Comparative Preparation | Cell could not be | Cell could not be |
| Example 3 | manufactured | manufactured |
| Comparative Preparation | 80 | L6 |
| Example 4 | | |
| Comparative Preparation | 80 | L6 |
| Example 5 | | |
| Comparative Preparation | 80 | L6 |
| Example 6 | | |

Referring to Table 4, the rechargeable lithium battery cells according to Preparation Examples 1-5 showed improved penetration stabilities compared to the cells according to Comparative Preparation Examples 1 to 6.

It should be understood that the embodiments described herein should be considered in a descriptive sense only and not for purposes of limitation. Descriptions of features or aspects within each embodiment should typically be considered as being available for other similar features or aspects in other embodiments.

The use of “may” when describing embodiments of the present disclosure refers to “one or more embodiments of the present disclosure”. In addition, as used herein, the terms “use”, “using”, and “used” may be considered synonymous with the terms “utilize”, “utilizing”, and “utilized”, respectively. As used herein, the terms “substantially”, “about”, and similar terms are used as terms of approximation and not as terms of degree, and are intended to account for the inherent deviations in measured or calculated values that would be recognized by those of ordinary skill in the art.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims, and equivalents thereof.

### DESCRIPTION OF SOME OF THE SYMBOLS

10: separator
20: porous substrate
30: heat resistance layer
40: positive electrode
50: negative electrode
60: electrode assembly
70: case

What is claimed is:

1. A separator for a rechargeable battery, comprising:
a porous substrate and a heat resistance layer on at least one surface of the porous substrate,
wherein the heat resistance layer comprises an acryl-based copolymer, a polyvinyl alcohol-based polymer, and a sheet-shaped inorganic particle,
the sheet-shaped inorganic particle is selected from mica, clay, magnesium hydroxide (Mg(OH)₂), aluminum hydroxide (Al(OH)₃), talc, and a combination thereof, and
a particle diameter of the sheet-shaped inorganic particle is about 0.1 μm to about 10 μm.

2. The separator of claim 1, wherein the acryl-based copolymer comprises a unit derived from (meth)acrylate or (meth)acrylic acid, a cyano group-containing unit, and/or a sulfonate group-containing unit.

3. The separator of claim 2, wherein the unit derived from (meth)acrylate or (meth)acrylic acid is represented by Chemical Formula 1, Chemical Formula 2, Chemical Formula 3, or a combination thereof: 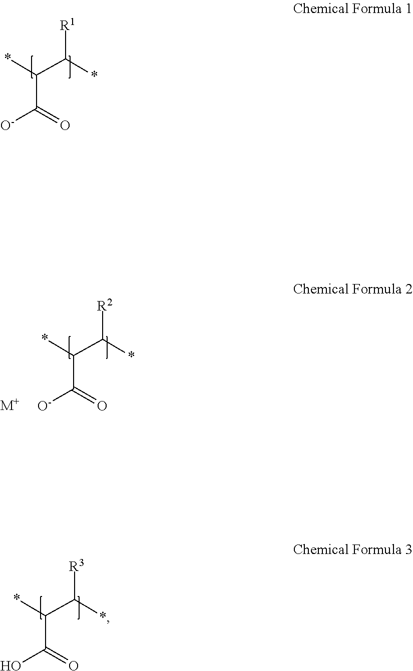
wherein, in Chemical Formula 1 to Chemical Formula 3,
R¹, R², and R³ are each independently a hydrogen atom or a methyl group, and in Chemical Formula 2, M is an alkali metal.

4. The separator of claim 2, wherein the cyano group-containing unit is represented by Chemical Formula 4: 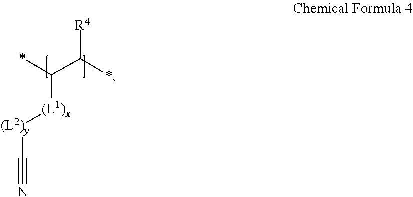
wherein, in Chemical Formula 4,
R⁴ is a hydrogen atom or a C1 to C3 alkyl group,
L¹ is —C(═O)—, —C(═O)O—, —OC(═O)—, —O—, or —C(═O)NH—,
L² is a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
x is an integer from 0 to 2, and
y is an integer from 0 to 2.

5. The separator of claim 2, wherein the sulfonate group-containing unit is represented by Chemical Formula 5, Chemical Formula 6, Chemical Formula 7, or a combination thereof: 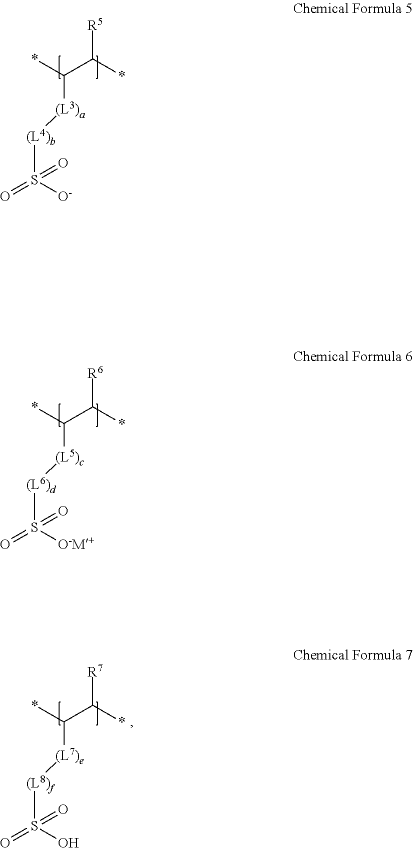
wherein, in Chemical Formula 5 to Chemical Formula 7,
R⁵, R⁶, and R⁷ are each independently a hydrogen atom or a C1 to C3 alkyl group,
L³, L⁵, and L⁷ are each independently —C(═O)—, —C(═O)O—, —OC(═O)—, —O—, or —C(═O)NH—,
L⁴, L⁶, and L⁸ are each independently a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
a, b, c, d, e, and f are each independently an integer ranging from 0 to 2, and
in Chemical Formula 6, M′ is an alkali metal.

6. The separator of claim 1, wherein the polyvinyl alcohol-based polymer comprises polyvinyl alcohol, modified polyvinyl alcohol, or a combination thereof.

7. The separator of claim 1, wherein an average thickness of the sheet-shaped inorganic particle is about 10 nm to about 500 nm.

8. The separator of claim 1, wherein a specific surface area of the sheet-shaped inorganic particle is about 1 m²/g to about 50 m²/g.

9. The separator of claim 1, wherein the acryl-based copolymer is included in an amount of about 1 wt % to about 30 wt % based on a total weight of the heat resistance layer.

10. The separator of claim 1, wherein the polyvinyl alcohol-based polymer is included in an amount of about 0.01 wt % to about 0.03 wt % based on a total weight of the heat resistance layer.

11. The separator of claim 1, wherein the sheet-shaped inorganic particle is included in an amount of about 50 wt % to about 99 wt % based on a total weight of the heat resistance layer.

12. The separator of claim 1, wherein a thickness of the heat resistance layer is about 0.01 μm to about 20 μm.

13. A rechargeable lithium battery, comprising:
a positive electrode, a negative electrode, and the separator for a rechargeable battery of claim 1 between the positive electrode and the negative electrode.
